(19) United States
(12) Patent Application Publication
(10) Pub. No.: US 2004/0083453 A1
(43) Pub. Date: Apr. 29, 2004

(54) Architecture for dynamically monitoring computer application data

(75) Inventors: Christine N. Knight, Toronto (CA); Geoffrey Robert Duck, King City (CA); Michael Starkey, Vancouver (CA); Vito Spatafora, Richmond Hill (CA)

Correspondence Address: Leslie A. Van Leeuwen, International Business Machines Corporation, Intellectual Property Law Department, 11400 Burnet Road, Austin, TX, 78758, US

(73) Assignee: INTERNATIONAL BUSINESS MACHINES CORPORATION, Armonk, NY

(21) Appl. No.: 10/462,515

(22) Filed: Jun. 16, 2003

(30) Foreign Application Priority Data
Oct. 25, 2002 (CA) 2,409,788

(51) Int. Cl. G06F 9/44

(52) U.S. Cl. 717/113; 717/105; 715/526; 345/700

(57) ABSTRACT

A dynamic application data monitoring architecture may include data collector, data provider, and widget software components. Data collectors convert application data from a native format into data instances having a logical hierarchical structure conforming to a schema which may be an XML schema. Data providers receive data instances from associated data collectors or other data providers and generate other data instances having a different logical hierarchical structure conforming to another schema which may be presentation-centric and may define features of a graphical data display mechanism (e.g. a line graph). The data provider may employ an external transform (e.g. an XSLT). Widgets receive logical, presentation-centric data instances from an associated data source (typically a data provider) and generate therefrom a displayable graphical representation of the received data according to an operative graphical data display mechanism. The data instances may be Document Object Model document instances.

### FIELD OF THE INVENTION

The present invention pertains to the field of computer applications, and more particularly to an architecture for dynamically monitoring computer application data.

### BACKGROUND OF THE INVENTION

Modern business enterprises employ computer applications in many aspects of their business. Dynamic monitoring of these applications (referred to as “business applications”) may thus be important for ascertaining the performance of the enterprise at any given time.

Most business applications have a user interface which provides feedback to the user at run time which allows the application to be visually monitored. Unfortunately, known application monitoring mechanisms tend to suffer from a number of drawbacks which are associated with their architecture.

For example, one problem with known architectures for monitoring application data is that they tend to be “hard-wired” at design time to a particular graphical data display mechanism having a particular appearance. For example, it may be determined at design time to display certain application data by way of a bar graph with a chosen font and text color. Accordingly, appropriate bar graph business logic (i.e. application-specific executable code) is hard-coded into the application source code. If it is later desired to adjust the bar graph's appearance (e.g. change the font or text color) or replace the bar graph with a different graphical data display mechanism that was not contemplated at design time (e.g. a line graph or a pie chart), the application must typically be upgraded through source code editing and must then be rebuilt to provide the desired view. This tends to be costly and time consuming.

Many known monitoring architectures suffer from a further disadvantage in that their components do not lend themselves to being reused or linked to existing monitoring components from other applications. For example, the combination of two categories of application data from distinct applications into a single view may not be possible without developer modification, recompilation and rebuilding of both applications. This too may be costly and time consuming.

A further disadvantage of known monitoring architectures is that they tend to support only local monitoring (e.g. at a monitor or display in close physical proximity to the hardware executing the application). If remote monitoring is in fact supported, proprietary software may be employed for the purpose of sending, receiving and processing application data between a server and remote clients. Development and incorporation of such proprietary software may disadvantageously add to the expense and complexity of the overall application. Moreover, processing of application data for display at remote clients tends to load client machines and may therefore degrade client efficiency.

Yet another problem associated with known monitoring architectures is that they are typically not easily modified to display application data by way of an alternative display device, such as a handheld wireless device rather than a computer monitor for example.

What is therefore needed is a dynamic business application data monitoring architecture which addresses at least some of the above noted disadvantages.

### SUMMARY OF THE INVENTION

A dynamic application data monitoring architecture may include data collector software components, data provider software components and widget software components.

Data collector software components (or simply “data collectors”) convert application data from its native format into data instances having a logical, hierarchical structure in order to facilitate access to the data by subsequent software stages ultimately tasked with its graphical display. Generated data instances conform to a logical schema, which may be a programming language and platform neutral schema such as an eXtensible Markup Language (XML) schema for example. The schema may be published to facilitate use of the data collector as a data source for subsequent software components, which may be one or more data providers and widgets. The generated data instance is typically application-data-centric but may in some cases be presentation-centric. An application-data-centric data instance is a data instance in which application data has a logical, hierarchical structure that is free of native format implementation details and in which elements and/or attributes are dictated by the application data rather than a particular graphical data display mechanism or mechanisms. A presentation-centric data instance is a data instance in which application data has a logical, hierarchical structure in which elements and/or attributes are dictated by a particular graphical display mechanism or mechanisms, such as a line graph or bar graph. Data collectors specify an Application Programming Interface (API) for updating, refreshing and returning generated data instances. The generated data instances may be Document Object Model (DOM) XML document instances, whose elements and attributes may be accessed through DOM API calls.

Data provider software components (or simply “data providers”) receive data instances from one or more architecture software components (which may be data collectors or other data providers) acting as their data source(s) and output other data instances to further architecture software components (which may be other data providers or widgets) ultimately tasked with graphical application data display. The output data instances conform to another logical schema which may be programming language and platform neutral (e.g. an XML schema) and may also be published. The input and output data instances may be application-data-centric or presentation-centric. Data providers specify an API for setting and getting data sources and for updating, refreshing and returning generated data instances. The specified API may be the DOM Document interface, which may be implemented by the data provider. When data providers implement the DOM Document interface, the generated data instances, which are DOM XML document instances, may comprise the data providers themselves, i.e. the data providers may in essence return themselves to subsequent architectural components.

Data provider software components may employ an external transform for transforming received data instances into generated data instances. In this case they are referred to as transform data provider software components (or simply “transform data providers”, abbreviated “TDPs”). The API of a transform data provider is extended from that of a basic data provider to include methods for creating/setting a transformer object as well as performing a transformation with that object. The external transform may be an eXtensible Stylesheet Language Transformation (XSLT). Because the transform is external to the TDP, modification of the transform may cause the structure or content of the data instance generated by the TDP to be changed without any modification of TDP source code, avoiding the need to recompile and rebuild software.

Widget software components (or simply “widgets”) receive logical, presentation-centric application data instances from an associated data provider acting as a data source for the widget and generate therefrom a displayable representation of the received data in the form of a particular graphical data display mechanism (e.g. line graph, bar graph, stacked bar graph, pie graph, or rate indicator) that the widget is designed to implement. The received data instances conform to a presentation-centric schema associated with the widget's operative display mechanism, which schema may be published to facilitate use of the widget in conjunction with data provider software components for displaying application data by way of a chosen display mechanism. The presentation-centric data instances received by a widget may be DOM XML document instances which conform to the DOM Document interface. The generated graphical representation may be in a two-dimensional vector graphics language, such as Scalable Vector Graphics (SVG) for example, so as to be displayable in a world wide web browser, either natively or with a suitable plug-in. Widget software components may be instances of Java™ classes which may constitute Java™ Beans. A widget's data source may be configurable at run time.

The architecture may be implemented according to the Model View Controller (MVC) paradigm. Data collectors may comprise the Model component; data providers may comprise the Controller component; and widgets may comprise the View component. A benefit of MVC paradigm compliance is modularity and component reusability.

Numerous implementations of the above described components are possible. In one embodiment, data collector software components, data provider software components, and widget software components are all implemented as Java™ objects. The objects are invoked from within a dynamic-content web page (e.g. a Java™ Server Page) whenever a browser displaying the page is refreshed. When invoked, the Java™ objects cooperate to supply dynamic content to the page in the form of displayable SVG code comprising a graphical representation of the application data of interest. Advantageously, in such an embodiment, standard software tools, such as an HTTP server application, a servlet engine and a world wide web browser, may be used to effect remote application data monitoring, through a data network such as the Internet for example. Advantageously, servlets and Java™ objects are executed at a central server, thus loading of client machines may be avoided.

In accordance with an aspect of the present invention there is provided a method of graphically displaying application data for dynamic monitoring comprising: constructing from native format application data a presentation-centric data instance in which application data is represented as a hierarchy of logical elements representing features of a graphical data display mechanism for displaying the application data, the logical elements being defined in a presentation-centric schema to which the data instance conforms.

In accordance with another aspect of the present invention there is provided a presentation-centric schema defining a hierarchy of logical elements representing features of a graphical data display mechanism for displaying application data.

In accordance with still another aspect of the present invention there is provided a widget software component comprising programmed instructions for directing a computing device to: receive from an associated data source a presentation-centric data instance in which application data is represented as a hierarchy of logical elements representing features of a graphical data display mechanism for displaying the application data, the logical elements being defined in a presentation-centric schema to which the data instance conforms; and generate from the presentation-centric data instance a displayable representation of the graphical data display mechanism having at least some of the features.

In accordance with yet another aspect of the present invention there may be provided a computer program product having media including computer programmed instructions for directing a computing device to implement the above noted method.

In accordance with still another aspect of the present invention there may be provided a computing device comprising a processor and persistent storage memory in communication with the processor storing processor readable instructions for directing the device to undertake the above noted method.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In the figures which illustrate exemplary embodiments of this invention:

FIG. 1 is a schematic diagram of a computing system exemplary of the present invention;

FIG. 2 illustrates the server of FIG. 1 in greater detail;

FIG. 3 is a schematic diagram illustrating data flow between software components in the computing system of FIG. 1;

FIG. 4 is a Unified Modeling Language (UML) model of a class from which the data collector software object shown in FIG. 3 is instantiated;

FIG. 5 illustrates an eXtensible Markup Language (XML) schema for a weekly shipments document instance that is generated by the data collector software object of FIG. 3;

FIG. 6A illustrates a weekly shipments document instance generated by the data collector software object of FIG. 3;

FIG. 6B illustrates the weekly shipments document instance of FIG. 6A in serialized XML form;

FIG. 7 is a UML model of a class from which the transform data provider software object shown in FIG. 3 is instantiated;

FIGS. 8A and 8B illustrate an XML schema associated with the line graph widget of FIG. 3;

FIG. 9 illustrates a transform employed by the transform data provider software object of FIG. 3 in eXtensible Stylesheet Language (XSL) notation;

FIG. 10A illustrates a line graph document instance generated by the data collector of FIG. 3;

FIG. 10B illustrates the line graph document instance of FIG. 10A in serialized XML form;

FIG. 11 is a UML model of a class from which the line graph widget software object shown in FIG. 3 is instantiated;

FIG. 12 illustrates a line graph showing application data in graphical form as may be displayed by the browser shown in FIG. 3;

FIG. 13 illustrates a Java™ Server Page (JSP™) shown in FIG. 2 in greater detail;

FIG. 14A is a UML sequence diagram illustrating object interaction in the computing system of FIG. 1 during system initialization;

FIG. 14B is a UML sequence diagram illustrating object interaction in the computing system of FIG. 1 upon a browser refresh at a client computer;

FIG. 15 illustrates in XSL notation an alternative transform that may be employed by the transform data provider shown in FIG. 3 in an alternative embodiment of the present invention;

FIG. 16 illustrates an alternative line graph showing application data as may be displayed by the browser of FIG. 3 when the transform of FIG. 15 is employed by the transform data provider;

FIG. 17 is a schematic diagram illustrating data flow between software components in another alternative embodiment of the computing system of FIG. 1;

FIG. 18 illustrates a line graph showing application data as may be displayed by the alternative embodiment of FIG. 17;

FIG. 19 is a schematic diagram illustrating data flow between software components in a further alternative embodiment of the computing system of FIG. 1; and

FIG. 20 illustrates a bar graph showing application data as may be displayed by the alternative embodiment of FIG. 19.

### DETAILED DESCRIPTION

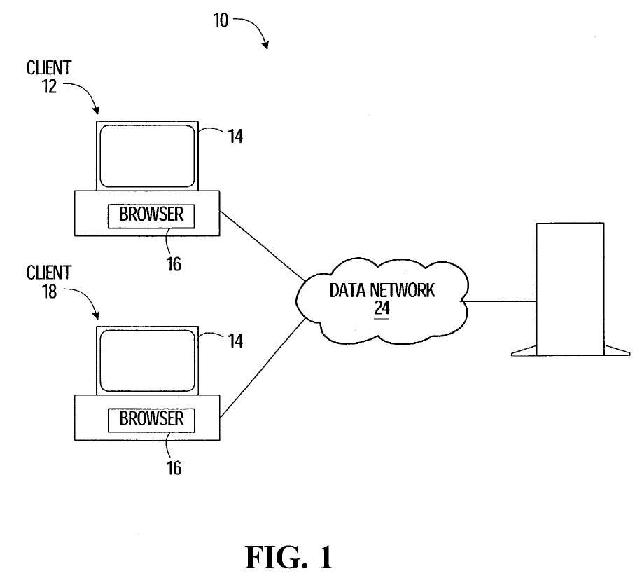

FIG. 1 illustrates a computing system 10 exemplary of the present invention. Computing system 10 includes two client computers 12 and 18 in communication with a server 26 over a data network 24. The client computers 12 and 18 and the server 26 may each be located at a distinct geographical location associated with a different branch office of a business enterprise for example.

Client computers 12 and 18 (also referred to simply as “clients”) are network-aware computing devices and as such each include a processor, memory, a network interface such as an Ethernet interface, and a keyboard (all not shown). Each client also has a display 14. The memory of each of clients 12 and 18 stores a browser 16, such as Microsoft Internet Explorer® for example, capable of displaying HyperText Markup Language (HTML) as well as Scalable Vector Graphics (SVG) data (or of supporting plug-ins which can display SVG). As known by those skilled in the art, SVG is a language for expressing two-dimensional vector graphics in eXtensible Markup Language (XML).

Data network 24 is the Internet in the present embodiment. However, in alternative embodiments, data network 24 may be a private local area network or any other type of data network known to those skilled in the art.

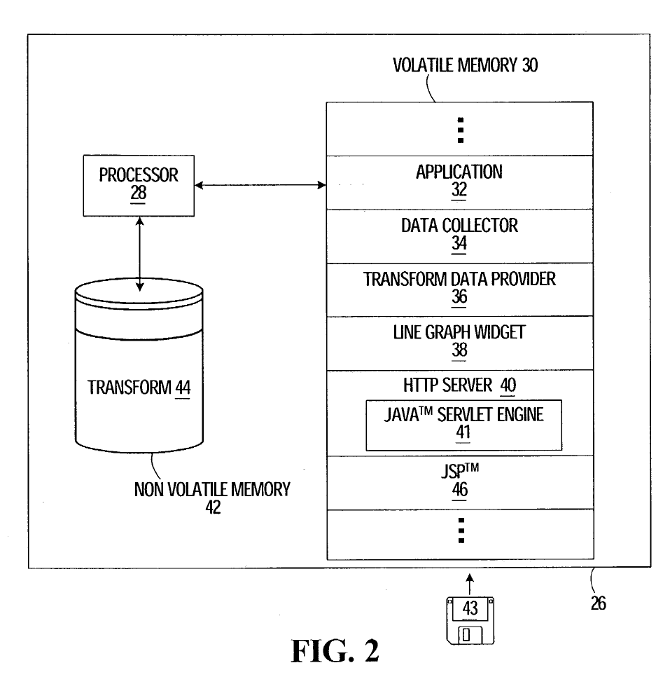

Server 26 is a network capable server. Server 26 is illustrated in greater detail in FIG. 2.

As shown in FIG. 2, server 26 includes a processor 28 in communication with volatile memory 30 (e.g. RAM) as well as non-volatile memory 42 (e.g. a hard drive). The interconnections between the volatile and non-volatile memories 30 and 42 and the processor 28 are conventional. The server 26 includes a network interface such as an Ethernet interface (not shown) for interconnection to the data network 24.

The volatile memory 30 of server 26 includes an application 32; a data collector software object 34; a transform data provider software object 36; a line graph widget software object 38; a HyperText Transfer Protocol (HTTP) server application 40 having a Java™ servlet engine 41; and a Java™ Server Page (JSP™) 46.

Application 32 is a software application which tracks shipments and deliveries of products from a business enterprise to its customers. It will be appreciated that applications in alternative embodiments of the computing system 10 may have a different purpose. In the present example, application 32 is a legacy application coded in the Java™ software programming language which has been modified by a developer (or “system architect”) of computing system 10 to support dynamic monitoring of certain application data at a client 12 or 18, in a manner that will be described herein.

The data collector software object 34 (also referred to simply as “data collector” and abbreviated “DC”) is a Java™ object which is capable of receiving event notifications from the application 32 regarding application data of interest and of generating therefrom an application-data-centric data instance on request. An application-data-centric data instance is a data instance in which application data has a logical, hierarchical structure that is free of native format implementation details and in which elements and/or attributes are dictated by the application data rather than a particular graphical data display mechanism or mechanisms (i.e. not dependent upon whether the application data will ultimately be displayed in the form of, e.g., a line graph versus a bar graph). The purpose of the data collector 34 is to convert application data of interest from its native format into a logical hierarchy to facilitate access to the data by subsequent software stages ultimately tasked with its graphical display. The generated data instance conforms to an application-data-centric schema (typically created by the developer of the data collector 34) that is published to facilitate use of the DC 34 as a data source by subsequent software stages, which are possibly developed by different developers.

In the present embodiment, the application-data-centric schema is an XML schema, and the application-data-centric data instance generated by the DC 34 is a Document Object Model (DOM) XML document instance. As known to those skilled in the art, DOM is a World Wide Web Consortium (W3C) recommendation which defines the logical structure of XML or HTML documents and a manner of accessing and manipulating such documents by way of a particular Application Programming Interface (API). DOM is not in itself a programming language, but rather may be implemented in any programming language (e.g. Java™), in the form of a software package or library for example, and may thereby be utilized in computer software to access, manipulate or otherwise manage XML documents comprising a hierarchy of instantiated objects representing XML elements and attributes. It will be appreciated that such implementation of a programming language and platform neutral data instance using a particular programming language (such as Java™) or particular platform does not cause the data instance to become programming language or platform dependent, but rather is done simply to permit interaction with the data instance. DOM XML document instances are capable of being queried as to, and of supplying, element and attribute values at run time. DOM XML document instances may also be amended or even created at run time through appropriate DOM API calls. The DOM recommendation with which the DOM XML document instances of the present embodiment are compliant is DOM Level 2, which is accessible at http://www.w3.org/TR/DOM-Level-2-Core/, and is hereby incorporated by reference hereinto.

Transform data provider software object 36 (also referred to simply as “transform data provider” and abbreviated “TDP”) is a Java™ object which is capable of receiving an application-data-centric data instance from an associated data collector and transforming it into a presentation-centric data instance. A presentation-centric data instance is a data instance in which application data has a logical, hierarchical structure in which elements and/or attributes are dictated by a particular graphical display mechanism or mechanisms (e.g. charts such as line graph, bar graph, stacked bar graph, pie graph or rate indicators). The elements and/or attributes represent features that are suited to (and possibly particular to) the operative graphical data display mechanism (e.g., in the case of a bar graph mechanism, a categorization description element, or in the case of a pie graph mechanism, a dataset percentage element). In the present embodiment, both the application-data-centric data instance received by the transform data provider and the presentation-centric data instance generated by the TDP are DOM XML document instances. However, because the TDP 36 implements the DOM Document interface, when the TDP 36 “generates” a presentation-centric data instance at the request of a subsequent software stage, it is in essence generating and returning itself.

It will be appreciated that the TDP 36 is generic in the sense that it is not “hard-wired” to specific input application-data-centric schema and output presentation-centric schema. Rather, the TDP 36 is configurable at run time with an external transform (described below) which wholly governs the transformation to be effected by the TDP 36. As will be appreciated, this aspect of the dynamic application data monitoring architecture promotes flexibility of application of the present embodiment to many distinct applications with only the provision of an appropriate transform.

Line graph widget software object 38 is a Java™ object capable of receiving a logical, presentation-centric data instance of line graph data from an associated data provider acting as the widget's data source and of generating displayable line graph data comprising SVG code therefrom. The received presentation-centric data instance conforms to a presentation-centric schema that is associated with the operative line graph display mechanism and thus defines elements and attributes that are suited to line graphs. This schema, which is an XML schema in the present embodiment, has been prepared by the developer of the widget 38 and published to facilitate use of the widget 38 in conjunction with any data provider whose output data is sought to be displayed in line graph form. It will be appreciated that only document instances conforming to the schema will be properly traversed and queried (through appropriate DOM API calls) at run time so as to result in the proper generation of displayable line graph data. It will further be appreciated that the line graph widget 38 is not “data-aware”, i.e. it is not cognizant of the semantic meaning of the line graph data that it converts to displayable form. As will become apparent, this permits the widget's data source to be “hot-swapped”, i.e. changed on-the-fly, at run time. In the present embodiment, the received presentation-centric data instance is a DOM XML document, and the widget 38 is implemented as a Java™ Bean.

HTTP server application 40 is a conventional HTTP server application which permits the server 26 to provide HTTP pages on demand to network interconnected computing devices, such as clients 12 and 18. HTTP server application 40 may be an Apache or IBM® HTTP server or similar application for example. As will be appreciated, the HTTP server application 40 facilitates the display of application data to a remote user by providing web pages including generated line graph SVG code to remote clients 12 or 18 for display by a browser 16.

Java™ servlet engine 41 is an add-on module to the HTTP server application 40 which permits Java™ servlets to be executed by the HTTP server application 40.

JSP™ 46 is a dynamic web page which employs JSP™ technology for dynamic control of its content and appearance. JSP™ 46 comprises static HTML as well as embedded calls to Java™ objects (comprising DC 34, TDP 36 and widget 38) which cause the objects to cooperate to supply dynamic content to the page consisting of application data in line graph form, as will be described.

The non-volatile memory 42 of server 26 stores a transform 44. Transform 44 is an eXtensible Stylesheet Language Transform (XSLT) which governs the manner in which the TDP 36 will transform application-data-centric data instances into presentation-centric data instances. As known by those skilled in the art, XSLT is a recommendation of the World Wide Web Consortium (W3C) describing how to transform an XML document having one structure into an XML document having a different structure. As will be appreciated, the transform 44 serves as a sort of external “plug-in” to the TDP 36 which may be changed between runs or at run time to modify the transformation performed by the TDP 36 and thereby control the appearance of the ultimately displayed line graph, without any need for software source code editing or a rebuild. Transform 44 is typically prepared by a system architect familiar with both the first, application-data-centric document schema and the presentation-centric document schema described above.

Application 32, data collector 34, transform data provider 36, line graph widget 38, transform 44 and JSP™ 46 may be loaded from a computer program product having a readable medium, such as a removable optical or magnetic disk 43.

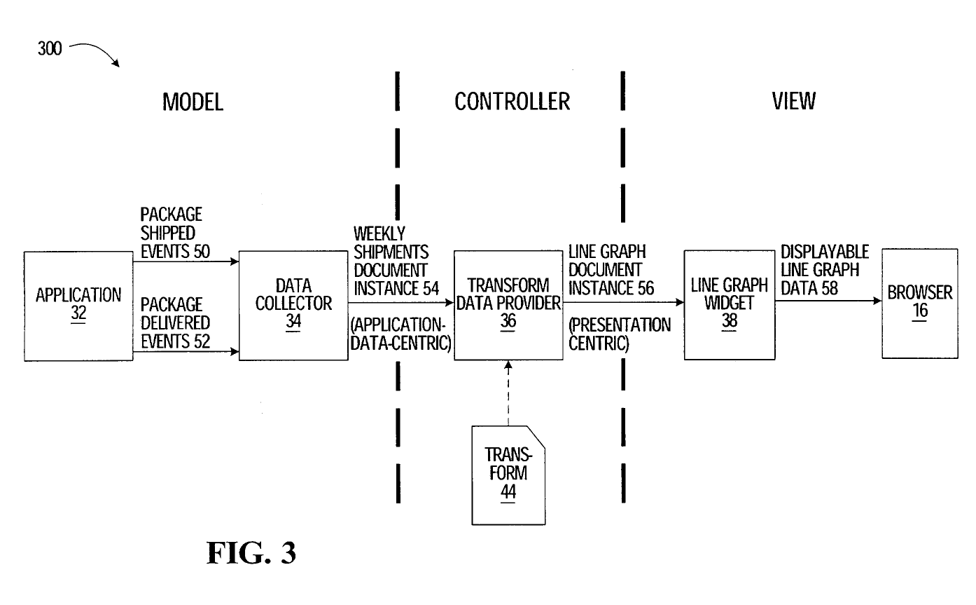

FIG. 3 is a data flow diagram 300 which illustrates the data flow between software components of computing system 10. As may be seen in FIG. 3, the computing system 10 is implemented according to the Model View Controller (MVC) paradigm. As known by those skilled in the art, the MVC paradigm dictates that a system's representation of “real-world” data, its user interface, and the manner of mapping the real world data representations to the user interface shall be handled by way of a separate “Model” component, “View” component, and “Controller” component, respectively. A benefit of adopting the MVC paradigm is modularity and component reusability. The MVC paradigm is described in G. E. Krasner and S. T. Pope, A Cookbook For Using the Model View Controller User Interface Paradigm in Smalltalk-80, Journal of Object Oriented Programming, 1(3): 26-49, August-September 1988, which is hereby incorporated by reference hereinto.

As shown in FIG. 3, the Model component is made up of the application 32 and data collector 34. In the present embodiment, application 32 provides native-format application data to the data collector 34 by way of notification of two types of events: package shipped events 50 and package delivered events 52. Event notification is achieved in the present embodiment by way of developer modification of the legacy application 32; code inserted by the developer causes events 50 and 52 to be published to event queues that are monitored by the DC 34. IBM® MQSeries Messaging middleware or similar software may be used for this purpose, as known by those skilled in the art.

The DC 34 receives notification of the package shipment and delivery events 50 and 52 and in turn generates (on request) a logical, application-data-centric DOM XML document instance 54 (also referred to as the “weekly shipments document instance” 54) representative of the package shipments/deliveries occurring during the current business week. The DC 34 locally compiles event data representative of the current business week's shipments and deliveries for this purpose.

The Controller component of the computing system 10 of the present embodiment comprises the transform data provider 36 and its associated transform 44. The TDP 36 receives the weekly shipments DOM XML document instance 54 and transforms this instance 54 into the presentation-centric DOM XML document instance 56 (also referred to as the “line graph document instance” 56). More specifically, application data from the document instance 54 is accessed using DOM API calls, and the line graph document instance 56 is created (on request, also using DOM API calls) as dictated by the transform 44.

The View component of computing system 10 includes the line graph widget 38 and the browser 16. The line graph widget 38 receives the line graph document instance 56 generated by the TDP 36 and generates therefrom (on request) displayable line graph data 58. More specifically, the widget 38 accesses document instance 56 (again using DOM API calls) and converts the accessed line graph data to corresponding SVG code. The generated SVG code is provided to the browser 16 as part of the JSP™ 46 (FIG. 1) for display to a user, who may thereby monitor the application 32.

As will become apparent, the data flow between the software components illustrated in FIG. 3 is triggered by the refresh of JSP™ 46 (FIG. 2) at browser 16 of client 12 or 18 (FIG. 1), with each refresh triggering a one-off passing of data from the DC 34 through to the browser 16. Event notification from the application 32 to the DC 34, on the other hand, occurs continuously as events 50 or 52 are generated by the application 32.

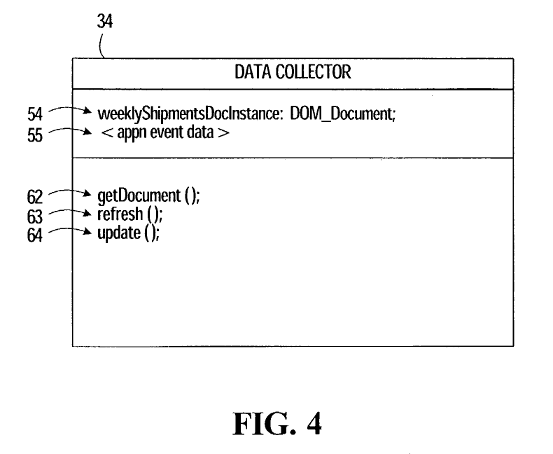

FIG. 4 is a Unified Modeling Language (UML) model of a class from which the data collector software object 34 is instantiated. The DC 34 includes a weeklyShipmentsDocInstance attribute 54 which is the application-data-centric DOM XML document instance 54 that is passed to the TDP 36 (FIG. 3). The DC 34 also includes application event data 55 comprising compiled event notifications received from the application 32 stored in appropriate variables.

The DC 34 includes a getDocument( ) method 62, a refresh( ) method 63, and an update( ) method 64. The getDocument( ) method 62 returns the weeklyShipmentsDocInstance attribute 54 (i.e. the application-data-centric data instance generated by the DC 34). The refresh( ) method 63 updates the weeklyShipmentsDocInstance 54 with current application event data 55, so that after it has been invoked the weeklyShipmentsDocInstance 54 reflects the current values of the application event data 55. The update( ) method 64 is similar to the refresh( ) method 63, except that whereas the refresh( ) method 63 causes the entire weeklyShipmentsDocInstance 54 to be updated, the update( ) method 64 may selectively update only part of the weeklyShipmentsDocInstance 54.

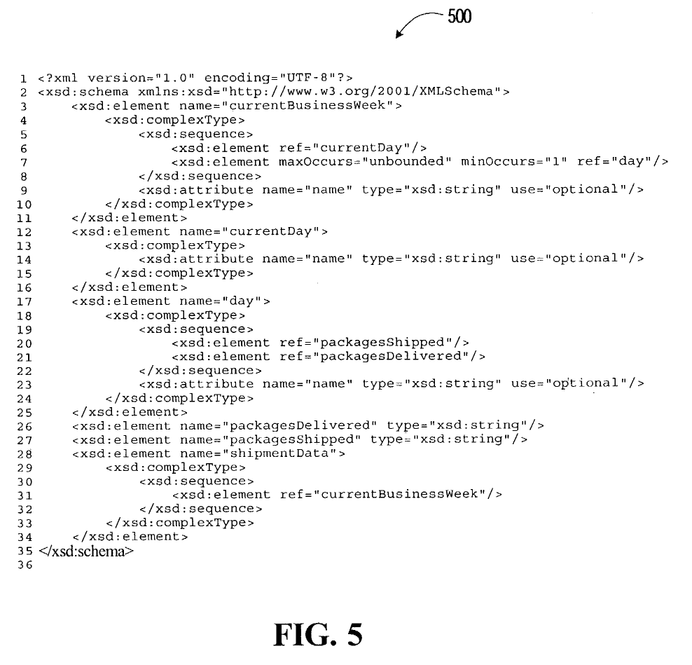

FIG. 5 illustrates a weekly shipments document schema 500 in XML notation. It is this schema 500 to which the weekly shipments document instance 54 (FIG. 3) conforms and to which a developer may have reference when creating transform 44 (for the purpose of determining the expected application-data-centric DOM document structure).

As may be seen in FIG. 5, the schema 500 defines a hierarchy of elements including a currentBusinessWeek element (line 3), a currentDay element (line 12), a day element (line 17), a packagesDelivered element (line 26), a packagesShipped element (line 27), and a shipmentData element (line 28). These elements facilitate the logical representation of a current business week's worth of package shipment and delivery data.

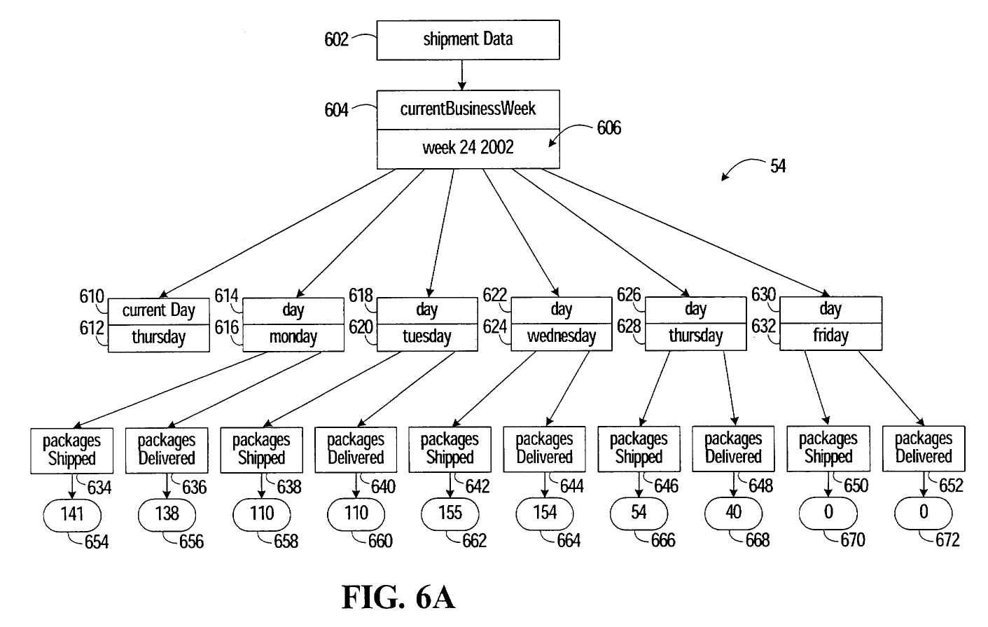

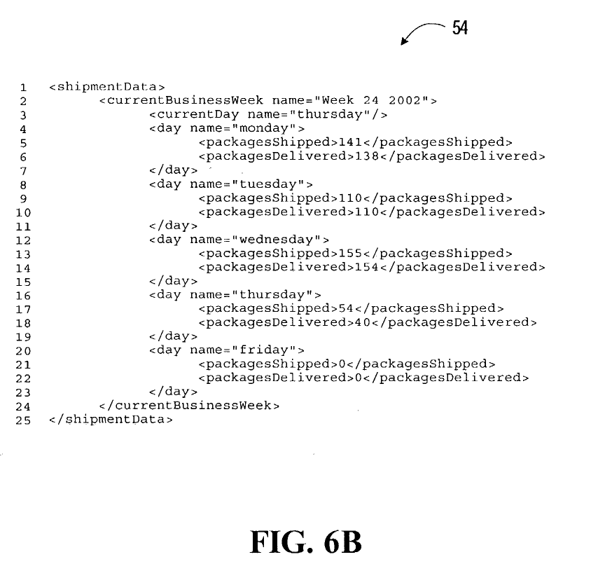

FIGS. 6A and 6B illustrate the weekly shipments document instance 54 of FIG. 3 as a DOM document and in serialized form, respectively.

Referring to FIG. 6A, the document instance 54 includes a shipmentData element 602 (line 1 FIG. 6B) containing a currentBusinessWeek element 604 (line 2 FIG. 6B) having a name attribute specifying a current business week identifier of “Week 24 2002”. The currentBusinessWeek element 604 in turn contains a currentDay element 610 (line 3 FIG. 6B) having a name attribute 612 which indicates that is the current day of the week is “thursday”. The currentBusinessWeek element 604 further includes five day elements 614, 618, 622, 626 and 630 (lines 4-23 of FIG. 6B) having name attributes 616, 620, 624, 628 and 632 (respectively) which represent the days of the business week. Each day element further contains a single packageShipped element 634, 638, 642, 646, or 650 and a single packagesDelivered element 636, 640, 644, 648 or 652 having values indicated at 654, 656, 658, 660, 662, 664, 666, 668, 670 and 672 representing the number of packages shipped and delivered (respectively) on the day in question.

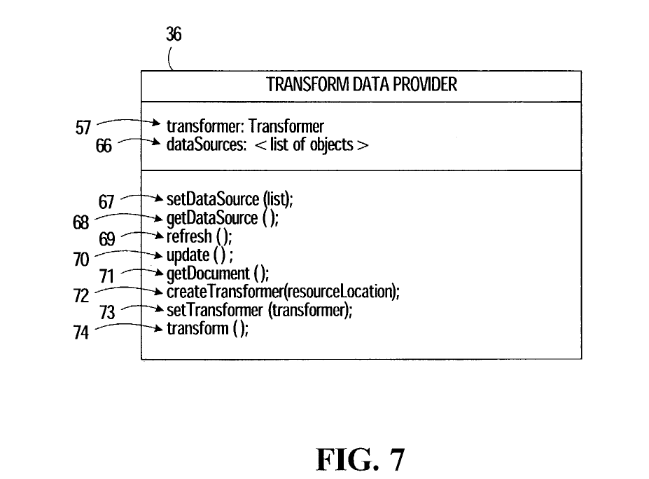

FIG. 7 is a UML model of a class from which the transform data provider software object 36 is instantiated. The TDP 36 includes a transformer object 57 containing business logic which, when executed, converts an application-data-centric DOM XML document instance to a presentation-centric DOM XML document instance 56. The TDP 36 further includes a dataSources attribute 66 which is a list of objects presently serving as the transform data provider's data source(s), from which application-data-centric document instances are to be received.

The TDP 36 includes eight methods, namely, the setDataSource( ) method 67, the getDataSource( ) method 68, the refresh( ) method 69, the update( ) method 70, the getDocument( ) method 71, the createTransformer( ) method 72, the setTransformer( ) method 73, and the transform( ) method 74.

The setDataSource( ) method 67 receives as an input parameter a list which contains one or more objects (e.g. data collectors). The method 67 sets the local dataSources attribute 66 to reference the passed object(s). This method provides a mechanism by which the TDP 36 is “linked” to its data source(s).

The getDataSource( ) method 68 returns a list contains one or more objects representing the current data source(s) of the TDP 36.

The refresh( ) method 69, update( ) method 70, and getDocument( ) method 71 are analogous in function to the methods of the data collector 34 (FIG. 4) of the same name, except that because the TDP 36 implements the DOM Document interface and is therefore itself a DOM Document, these methods in essence refresh, update, and return the TDP 36 itself (that is, the TDP 36 itself constitutes the presentation-centric DOM XML document instance 56 of FIG. 3).

With reference to the update( ) method 70, this method invokes the update( ) method 64 of the associated data collector(s) (as identified by the dataSources attribute 66) to ensure that the application data received from the data collector is current, and thereafter invokes TDP's transform( ) method 74 (described below) to selectively update the presentation-centric DOM XML document instance 56 (i.e. TDP 36) with current information, which in the present case is line graph information.

The createTransformer( ) method 72 receives a “resourceLocation” input parameter representing a path to a transform 44 and creates the transformer object 57 which may be used to transform the application-data-centric DOM XML document instance 54 to the presentation-centric DOM XML document instance 56.

The setTransformer( ) method 73 receives a “transformer” input parameter representing a transformer object and which may be used to transform the application-data-centric DOM XML document instance 54 to the presentation-centric DOM XML document instance 56, and sets the transformer attribute 57 to that received object.

The transform( ) method 74 invokes the transformer object 57 to convert the application-data-centric DOM XML document instance 54 to the presentation-centric DOM XML document instance 56.

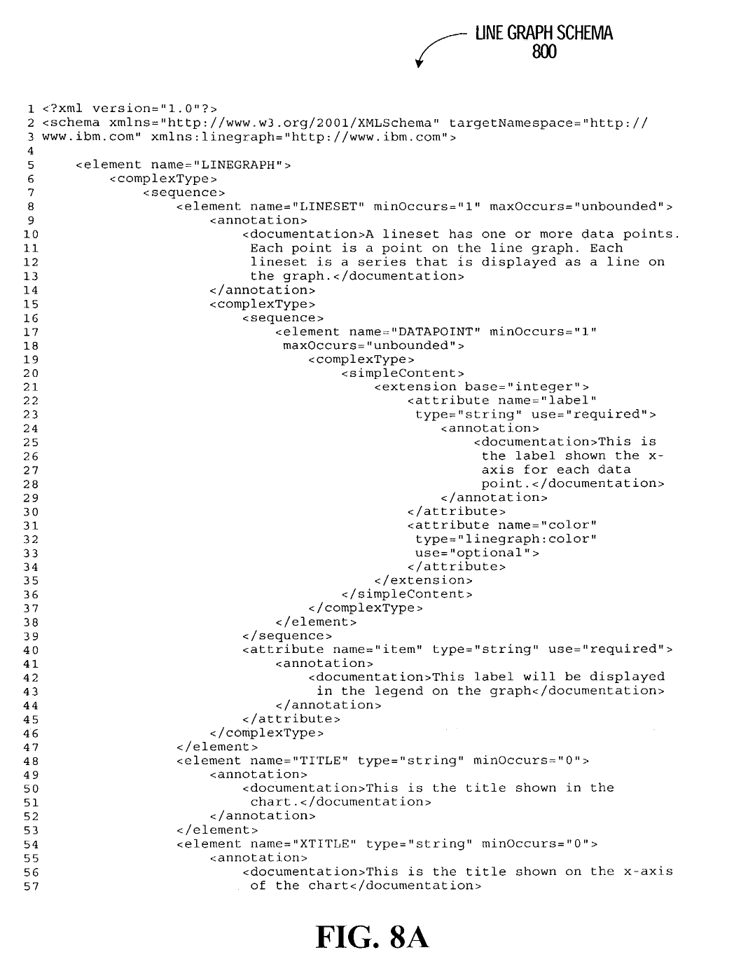

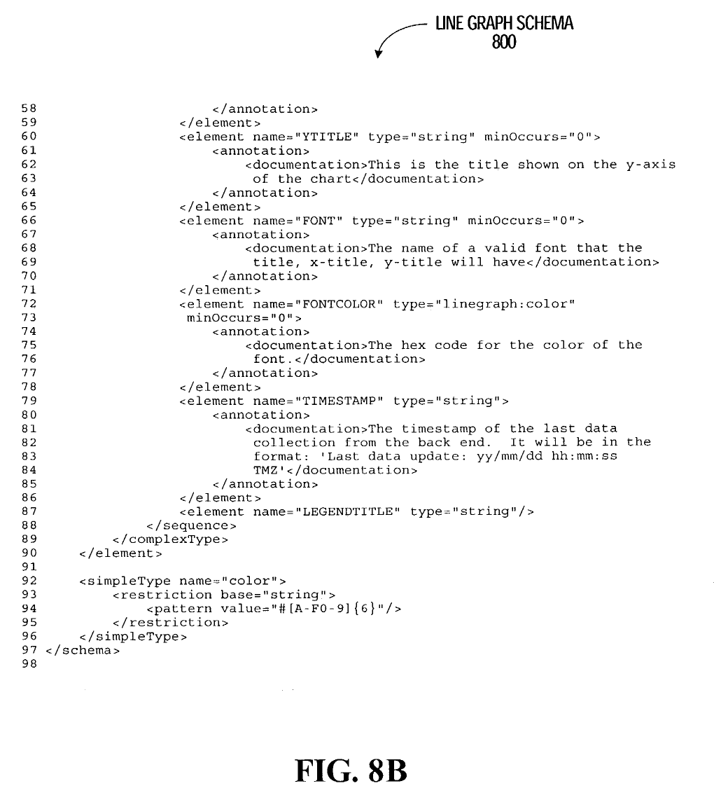

FIGS. 8A and 8B illustrate in XML notation the operative presentation-centric schema 800 of the present embodiment. It is this schema 800 to which the presentation-centric DOM XML document instance 56 conforms. More specifically, schema 800 is the schema to which the author of the transform 44 may have reference to ensure that the TDP 36 will generate conforming document instances 56. As may be seen, the schema 800 defines a hierarchy of elements associated with the features of a line graph, including: a lineset element (line 8) defining a line of the line graph; a datapoint element defining a data point of a line; a title element (line 48) defining the title of the line graph; an xtitle element (line 54) defining the textual label applied to the X-axis of the line graph; a ytitle element (line 60 of FIG. 8B) defining the textual label applied to the Y-axis of the line graph; and a number of other elements, including a legendtitle element (line 87) defining the title of the line graph's legend (if one exists). The datapoint element (line 21 of FIG. 8A) extends the base type “integer”, thus the line graph's data points are integer values. It will be appreciated that a datapoint element's “label” attribute (line 22) defines the textual label which appears below an associated data point on the line graph's X-axis.

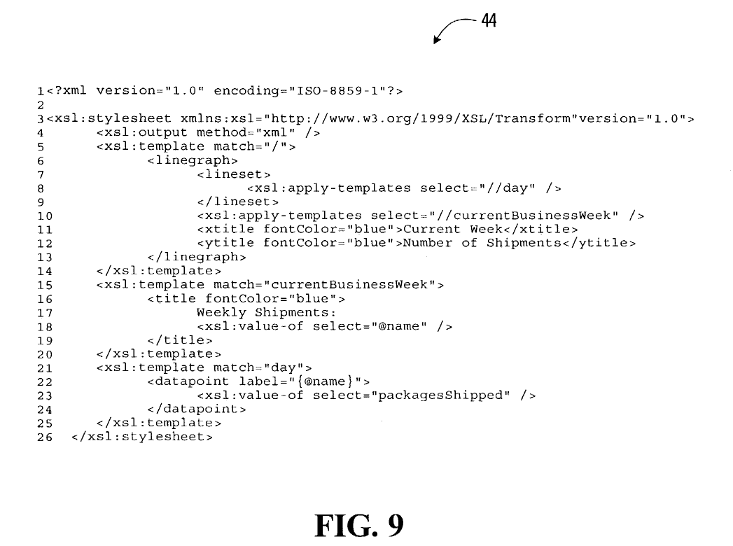

FIG. 9 illustrates the transform 44 employed by the transform data provider 36. As described, transform 44 is an XSLT. It will be noted that the transform 44 does not cause each element in an input application-data-centric document instance to be transformed into corresponding element in the output line graph document instance; rather, selected elements are transformed. For example, the tag at line 23 (FIG. 9) will cause package shipment data to transformed to line graph data, yet there are no tags in the transform 44 to cause package delivery information to be transformed into corresponding line graph data. This illustrates the fact that the transform author has control over which application data is to be transformed and ultimately displayed.

It will be appreciated with respect to FIG. 9 that, in addition to controlling the semantic content of the line graph display mechanism (as described above), the transform 44 of the present embodiment also controls features of the line graph display mechanism that are strictly aesthetic. For example, at lines 11, 12 and 16, transform 44 causes the font color of line graph text to be set to blue. Of course, such control of aesthetic features of the widget is only possibly because the line graph widget 38 is designed to permit such font color-based configuration settings within the associated presentation-centric DOM XML document instance 56. Other widgets may not have such capabilities and thus may not support the control of aesthetic display mechanism features through mere transform modification.

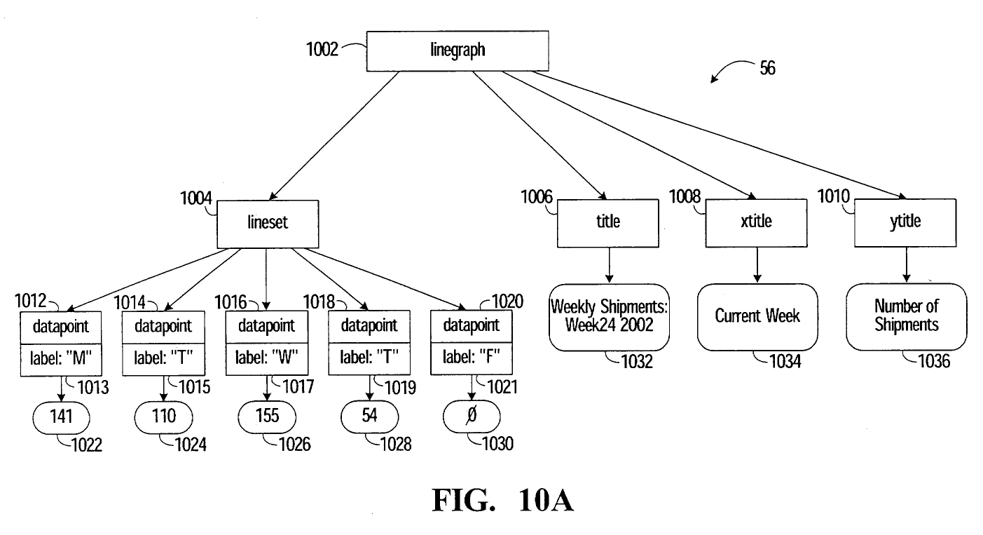

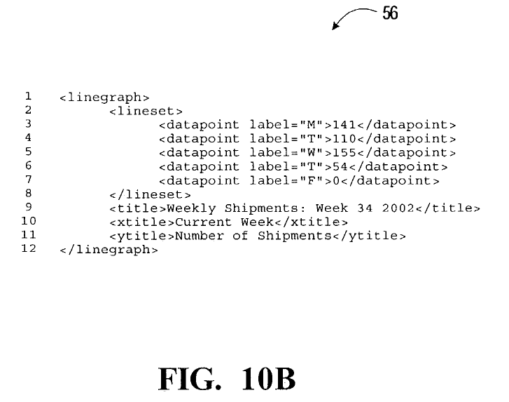

FIGS. 10A and 10B illustrate the presentation-centric line graph document instance 56 as a DOM document and in serialized form, respectively.

Referring to FIG. 10A, the document instance 56 includes a linegraph element 1002 (line 1 FIG. 10B) containing a lineSet element 1004 (line 2 FIG. 6B). The latter element is associated with a single line interconnecting data points of the line graph. The lineset element 1004 contains five datapoint elements 1012, 1014, 1016, 1018 and 1020 (lines 3 to 7 of FIG. 10B) with label attributes specifying single-character weekday abbreviations “M”, “T”, “W”, “T”, and “F” at 1013, 1015, 1017, 1019 and 1021 respectively. As will be appreciated, the values of these datapoint elements (i.e. integer values 141, 110, 155, 54, and 0), which are indicated at 1022, 1024, 1026, 1028 and 1030 respectively, correspond to “packagesShipped” element values in the application-data-centric document instance 54 (FIGS. 6A and 6B) representing a number of packages shipped on each day of the current business week. The document instance 56 further includes a title element 1006 (line 9 of FIG. 10B), an xtitle element 1008 (line 10 of FIG. 10B), and a ytitle element 1010 (line 110 of FIG. 10B) having values of “Weekly Shipments: Week 24 2002” (at 1032), “Current Week” (at 1034), and “Number of shipments” (at 1036) respectively.

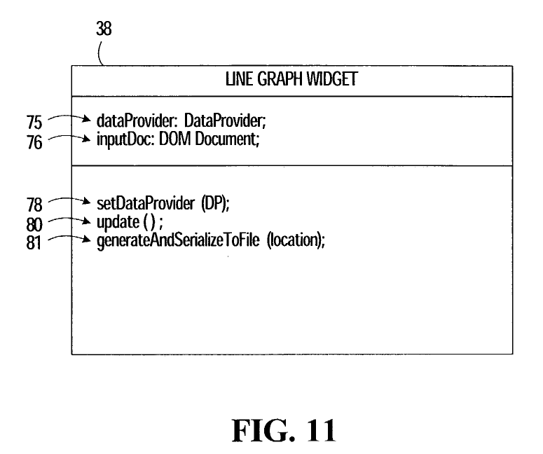

FIG. 11 is a UML model of the line graph widget 38. The widget 38 includes a dataProvider attribute 75 which uniquely identifies the data provider from which the presentation-centric DOM XML document instances 56 are to be received. The widget 38 also includes an inputDoc attribute 76 which references the DOM XML document instance 56 most recently input from the widget's data source.

The line graph widget 38 includes three methods, namely, the setDataProvider( ) method 78, the update( ) method 80, and the generateAndSerializeToFile( ) method 81.

The setDataProvider( ) method 78 receives a reference to a data provider object “DP” as an input parameter and sets the local dataProvider attribute 75 to reference the passed object. This method provides a mechanism by which the widget 38 is “linked” to its data source.

The update( ) method 80 is responsible for generating displayable line graph data 58 (FIG. 3) in the form of SVG code based on the most recent line graph data. The update( ) method 80 initially invokes the getDocument( ) method 71 (FIG. 7) of the associated data provider, as determined by the dataProvider attribute 75, and then invokes the local generateAndSerializeToFile( ) method 81 to generate SVG code representative of a line graph.

The generateAndSerializeToFile( ) method 81 generates SVG code from the inputDoc attribute 76 and directs it to a specified file location.

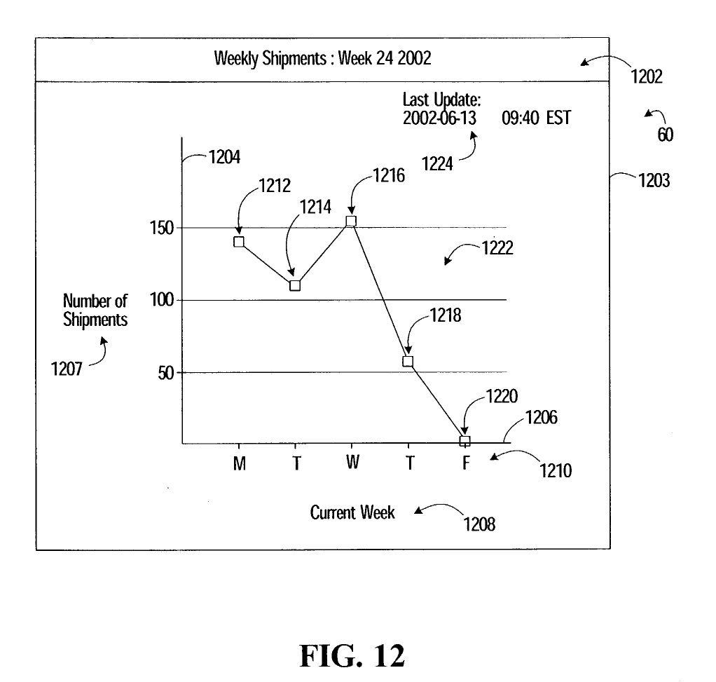

FIG. 12 illustrates a line graph 60 showing weekly shipment application data as may be displayed by the browser 16 displaying SVG code generated by the widget 38 from the line graph document instance of FIG. 10A. Line graph 60 has various conventional line graph features including a title 1202 and a graph portion 1203. The graph portion 1203 includes an X-axis 1206 having an X-axis title 1208 and a Y-axis 1204 having a Y-axis title 1207. The line graph 60 has a single line indicated generally at 1222. The line 60 is defined by five data points 1212, 1214, 1216, 1218 and 1220, each representing a number of package shipments occurring on a particular business day (the number being reflected by the vertical position of the points on the Y-axis 1204). Each data point has a single-character label identifying a particular weekday with which the point is associated, which labels are indicated cumulatively at 1210. The graph portion 1203 additionally includes a time stamp 1224 reflecting the time of last update of the data represented by the line 1222. Although not apparent from FIG. 12, all the text of line graph 60 is displayed in a blue font.

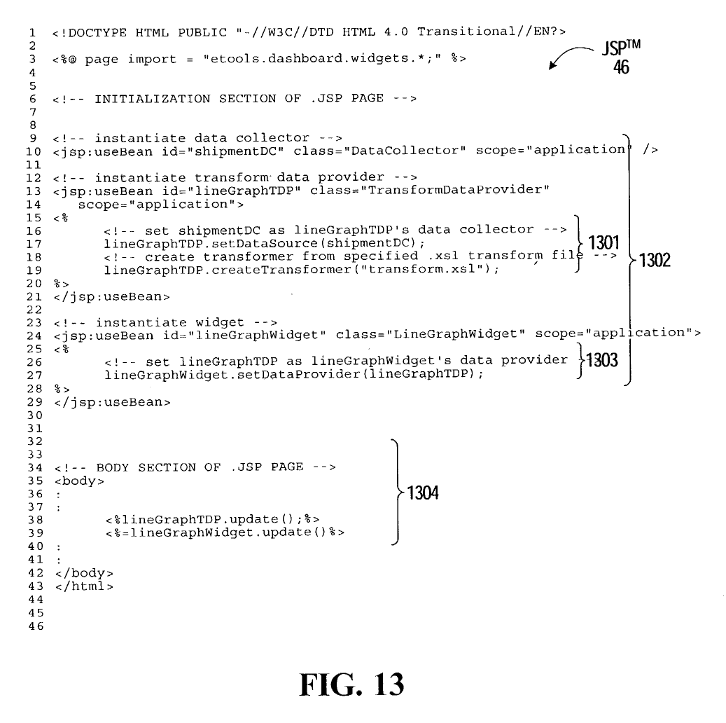

FIG. 13 illustrates the JSP™ 46 of FIG. 2 in greater detail. JSP™ 46 has two code portions: initialization code 1302 and body portion 1304. As will be appreciated by those skilled in the art, the execution of initialization code 1302 occurs when the JSP™ is loaded, and does not recur for the life of the JSP™ (due to the setting of an “application” scope of the objects at lines 10, 14 and 24). The body portion 1304, on the other hand, is executed once every time the browser 16 (FIG. 1) is refreshed. Initialization code 1302 includes code fragments 1301 and 1303 comprising calls to the transform data provider 36 and widget 38 which serve to “link” these objects to the line data collector 34 and thereby create a flow of data from the application 32 through to the widget 38, as will be described. The body portion 1304 includes a call to the line graph widget 38 which triggers generation of the line graph SVG code and results in its in-line incorporation into the page 46. It will be appreciated that an “embed” or “object” tag may be necessary to display generated SVG code by way of a browser plug-in, which tag may be unnecessary for browsers natively supporting SVG. The vertically aligned colons at lines 36, 37, 40 and 41 of the body 1304 represent HTML code comprising fixed web page content which has been omitted for clarity.

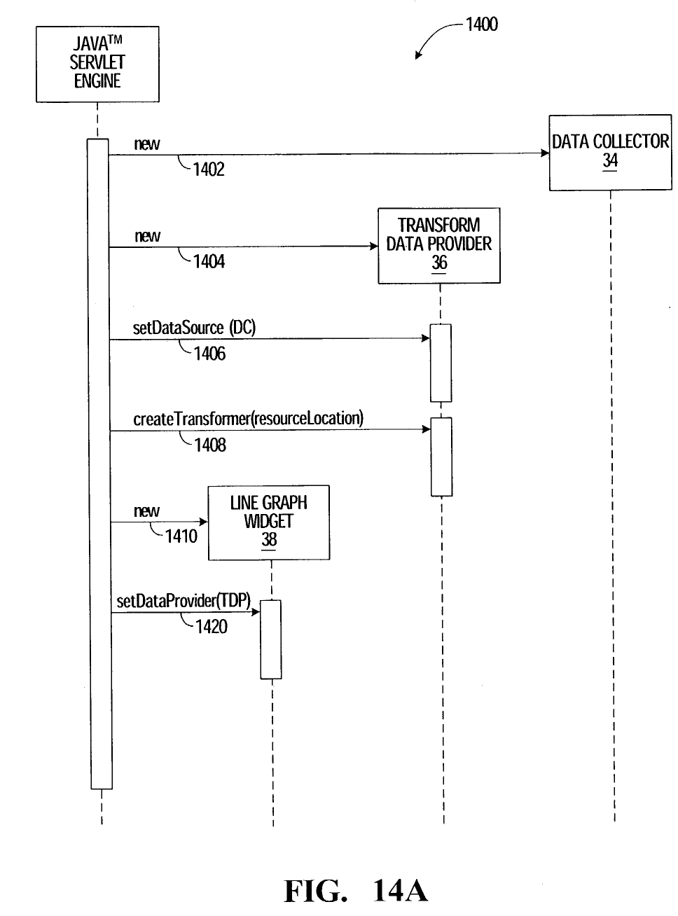

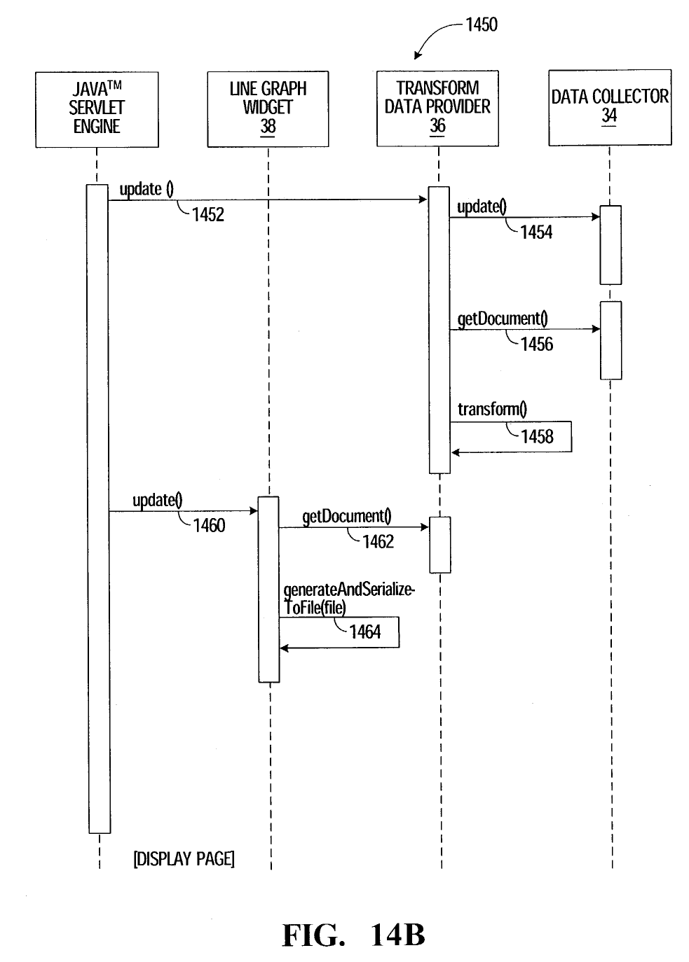

The operation of the present embodiment is illustrated in the UML sequence diagrams of FIGS. 14A and 14B respectively, with additional reference to FIGS. 1-4, 7, and 11-13. UML sequence diagram 1400 of FIG. 14A illustrates interaction between software components of the computing system of FIG. 1 during system initialization, while UML sequence diagram 1450 of FIG. 14B illustrates software component interaction upon a browser refresh at a client computer 12 or 18. It will be appreciated that the sequence diagram 1400 corresponds to the processing of the initialization code 1302 of the JSP™ 46 (FIG. 13) while sequence diagram 1450 corresponds to the processing of the body 1304 of JSP™ 46.

Referring to FIG. 14A, it is initially assumed that the application 32 (FIG. 2) is executing and that a user at client 12 or 18 has initially invoked the browser 16 and directed it to a URL at which the JSP™ 46 (FIG. 13) resides. The loading of JSP™ 46 causes the initialization code 1302 to be processed.

Processing of the “useBean” Java™ tag at line 10 (FIG. 13) triggers the instantiation 1402 (FIG. 14A) of the specified object DC 34, which is identified by the useBean element's “id” attribute value “shipmentDC”. The value “application” of the “scope” attribute of the useBean element causes the instantiated data collector 34 to have an application scope, i.e. the DC 34 will persist as long as the application is executing. The application scope also means that the DC 34 is instantiated and initialized the first time the JSP™ is executed, and that this instance is used by all browser instances which access the JSP™. It will be appreciated that a JSP™ developer may choose to adopt a different scope in an alternative embodiment.

Transform data provider 36 is instantiated next (at 1404 of FIG. 14A) upon the processing of the “useBean” tag at line 13 (FIG. 13), in a similar manner.

Subsequently, the setDataSource( ) method 67 of the TDP 36 is called at 1406 (line 17 of FIG. 13), a list containing the newly instantiated DC 34 being passed in as the input parameter. This call 1406 effectively sets the DC 34 as the data source for the TDP 36.

Thereafter, a call 1408 is made to the createTransformer( ) method 72 of the TDP 36 (line 19 of FIG. 13). This call 1408 causes the transform 44 (FIG. 2) specified by the input “resourceLocation” parameter to be accessed and business logic to be generated therefrom for converting an application-data-centric DOM XML document instance 54 (representing a business week's worth of package shipment/delivery data) to a presentation-centric DOM XML document instance 56 (representing line graph data), in the form of transformer object 57. It will be appreciated that the createTransformer( ) method 72 generates but does not execute the transformer object 57. Method 70 may entail the use of a commercially available stylesheet processor, such as the Xalan XSLT Stylesheet processor from the Apache Software Foundation, as will be appreciated by those skilled in the art.

The line graph widget 38 is instantiated next at 1410 upon the processing of the “useBean” tag at line 24 (FIG. 13). Subsequently, a call 1420 is made to the setDataProvider( ) method 78 (FIG. 11) of the widget 38 (line 27 of FIG. 13), with a reference to the TDP 36 being passed as an input parameter. This call 1420 effectively sets the TDP 36 as the data source for the line graph widget 38. Processing of the initialization code 1302 is thus concluded.

Following initialization, the DC 34 receives event notifications of shipment and delivery events 50 and 52 (FIG. 3) from the application 32 as the events occur, in a conventional manner. It will be appreciated that these event notifications may pertain to previously occurring events (e.g. data regarding a previous day's shipments).

At this stage, and every time that a person at client computer 12 or 18 using a browser 16 (FIG. 1) with the JSP™ 46 loaded thereinto subsequently refreshes his or her browser screen, a transmission of the JSP™ 46 from the server 26 to the browser 16 by HTTP server application 40 (FIG. 2) is triggered. Before such transmission occurs, the code at lines 37 and 38 of FIG. 13 within the body of the JSP™ 46 is executed to “crystallize” the dynamic content of the page for the instant display request. This is illustrated in the sequence diagram 1450 of FIG. 14B.

Processing of the code at line 37 of FIG. 13 causes the update( ) method 70 (FIG. 7) of the TDP 36 to be invoked at 1452 (FIG. 14B). The update( ) method 70 initially invokes the update( ) method 64 (FIG. 4) of the associated DC 34 at 1454. Upon being invoked, the latter update( ) method 64 generates a current version of the weekly shipments document instance 54 from current application event data 55 (FIG. 4). This generated document instance 54 is returned to the TDP 36 by way of a call 1456 to the getDocument( ) method 62. The update( ) method 70 of TDP 36 thereafter invokes the transform( ) method 74 (FIG. 7) at 1458 to create an updated version of the DOM XML document instance 56 (i.e. an updated version of the TDP 36) using the current weekly shipment information from DOM XML document instance 54.

Subsequently, processing of the code at line 38 of FIG. 13 causes the update( ) method 80 (FIG. 11) of the line graph widget 38 to be invoked at 1460. Upon being invoked, the update( ) method 80 initially invokes the getDocument( ) method 71 (FIG. 7) of the TDP 36 at 1462 to retrieve the now-updated line graph document instance 56 from the TDP 36 (i.e. to cause the TDP 36 to “return itself”). Thereafter, the method 80 invokes the generateAndSerializeToFile( ) method 81 of widget 38 at 1464 to generate corresponding SVG code to a specified file. The generated SVG code is incorporated in-line into the body of the JSP™ 46, either by way of a JSP™ expression (e.g. as indicated by the “<%=” and “%>” delimiters at line 39 of FIG. 13) if the browser supports in-line SVG code, or by added “embed” or “object” tags if SVG is supported by a browser plug-in. Execution of the sequence diagram 1450 having been completed, the JSP™ 46 (with its dynamic content now crystallized) is sent to the appropriate client 12 or 18 by the HTTP server application 40 and is displayed by the browser 16. The line graph 60 (FIG. 12) is thus displayed to the user at display 14, who may accordingly monitor the data of application 32.

It will be appreciated that the processing illustrated in sequence diagram 1450 (FIG. 14B) occurs at the server 26 rather than at clients 12 or 18 (FIG. 1). Advantageously, the loading of client computers 12 and 18 is thereby limited.

Each refresh of the browser will cause the steps associated with sequence diagram 1450 (FIG. 14B) to be repeated, thus repeated refreshes may cause the application data being monitored to be updated in near real-time, depending of course on such factors as the frequency of refresh requests, the frequency of event notifications 50 and 52 (FIG. 3) and the delay introduced by the data network 24 (FIG. 1). The time stamp 1224 (FIG. 12) will be updated to indicate the time of last update of the displayed data. It will be appreciated that automatic, periodic web page refresh is not implemented in the present embodiment in order to permit the user to have control over the timing of application data updates, so that displayed application data may be inspected at the user's convenience without fear of it being automatically overwritten. Of course, automatic refresh may be implemented if desired in alternative embodiments.

It will be appreciated that, because widgets are not “data-aware”, the architecture of the instant embodiment permits “hot-swapping” of a widget's data sources at run time. For example, if it is desired to view an alternative category of application data (e.g. employee attendance) in the form of a line graph, the same line graph widget 38 may be used to display this data within the JSP™ 46. Assuming that another transform data provider analogous to TDP 36 is available which is capable of providing this alternative category of application data in the form of a DOM XML document instance 56 conforming to the line graph schema 800 (FIGS. 8A and 8B), all that would be required at run time to cause a graphical representation of this data to be generated would be a call to the widget's setDataProvider( ) method 78 (FIG. 11) to set the alternative TDP as the new data source for the widget 38, followed by the familiar calls to the alternative TDP's update( ) method 70 and the widget's update( ) method 80 at run time (as described above in reference to FIG. 14B) to trigger SVG code generation. Such hot-swapping capability provides system flexibility for displaying a broad range of application data at run time with a minimum of overhead (in terms of instantiated objects).

In the event that it is desired to change the display device from a display 14 on a client computer 12 or 18 to, say, a wireless display device, the computing system 10 may be easily modified to accommodate the new display device. In this case, a new widget may be substituted for the line graph widget 38 which generates displayable data in, e.g., Wireless Markup Language (WML) versus SVG code. Advantageously, all remaining software components could be the same, and no software source code changes to the existing components or software rebuild would be required (though it may be necessary in some cases to implement environment changes, e.g., rather than JSP™, to utilize some other program that uses the components).

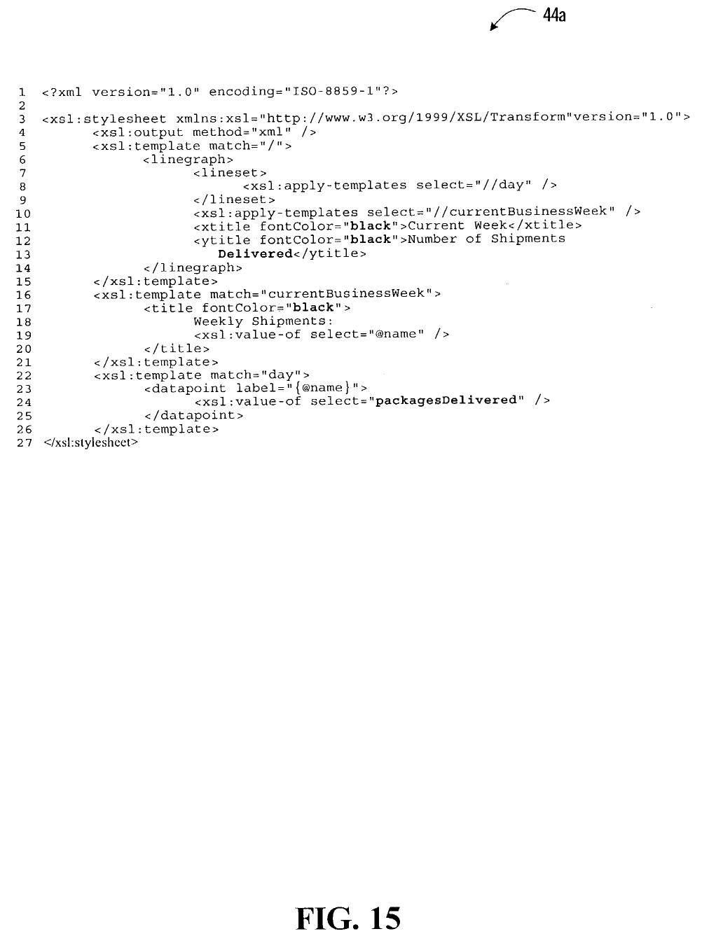

FIG. 15 illustrates an alternative transform 44a which may be substituted for the transform 44 (FIG. 9) of the computing system 10 of FIG. 1 to change the semantic and aesthetic content of the displayable line graph. Changes from the previous transform 44 of FIG. 9 are indicated in bold. The semantic changes include adding the work “Delivered” to the title (at line 13) and specifying a “packagesDelivered” element instead of a “packagesShipped” element at line 24, to indicate that package delivery information versus package shipment information is displayed in the line graph. The aesthetic changes consist of setting the font color to black instead of blue at lines 11, 12 and 16.

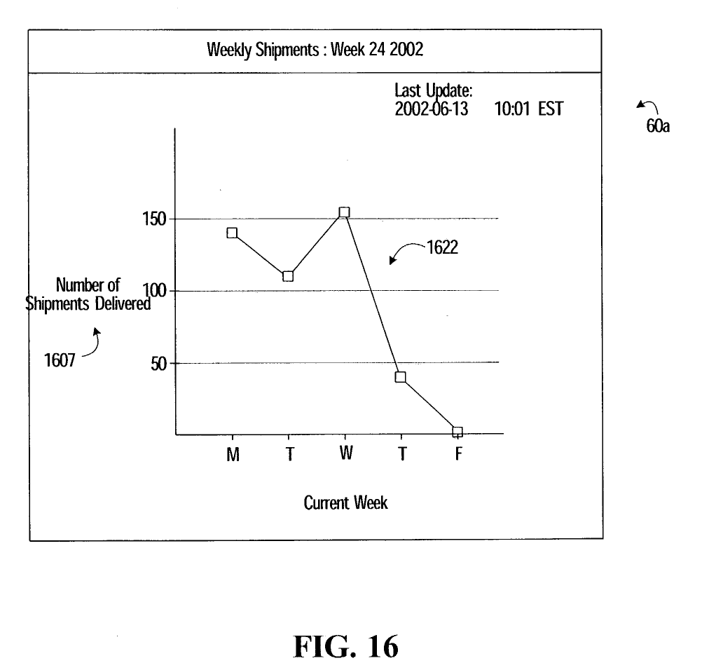

Prior to operation, the transform 44a is substituted for transform 44 in non-volatile memory 42 (FIG. 2). Thereafter, operation of the computing system occurs as shown in FIGS. 14A and 14B, except that when the createTransformer( ) method call 1408 (FIG. 14A) is made during system initialization, the transformer object that is created is based on transform 44a, rather than transform 44. As a result, when the transform( ) method call 1458 (FIG. 14B) is made in response to a browser refresh during operation, a different line graph document instance 56 (not shown) will be generated which incorporates the above-described semantic and aesthetic changes. When this document instance is used to generate line graph data 58, the line graph 60a of FIG. 16 results.

As may be seen in FIG. 16, the values of the data points comprising line 1622 have changed due to the fact that deliveries, not shipments, are now graphed. The Y-axis title 1607 “Number of Shipments Delivered” (formerly “Number of Shipments”) is updated to reflect this change. In addition, although not apparent from FIG. 16, the text of the line graph 60a is displayed in a black font.

Advantageously, both the semantic and aesthetic content of the displayed application data has been changed by changing only the external transform, without any need for software source code updates or a software rebuild. The person updating the software need not even understand the interaction between the software components comprising the computing system 10, but rather is only required to be able to read XML schemas and author XSLTs.

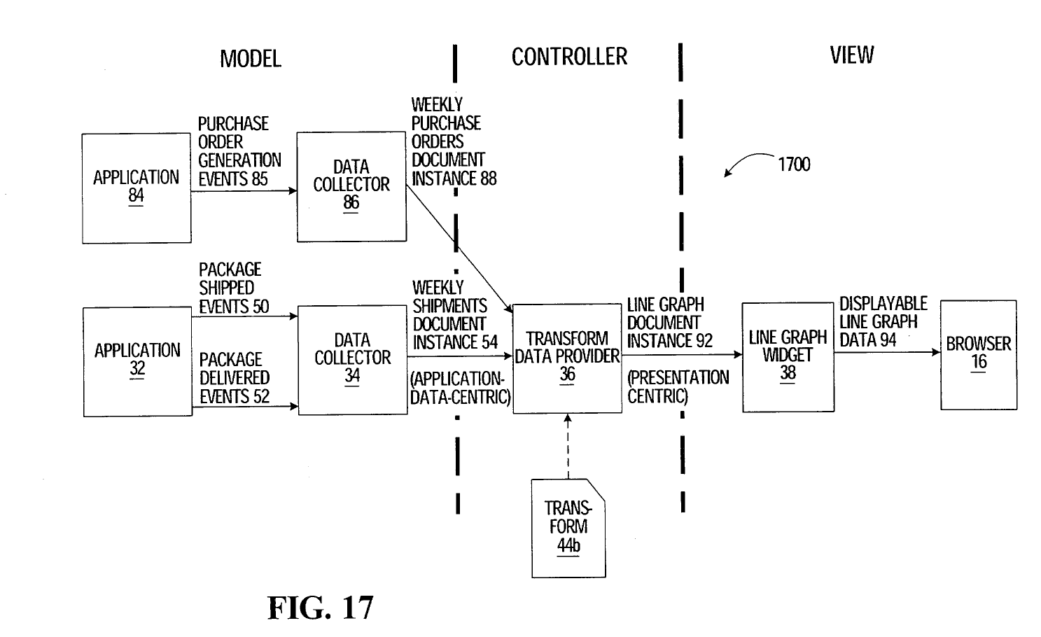

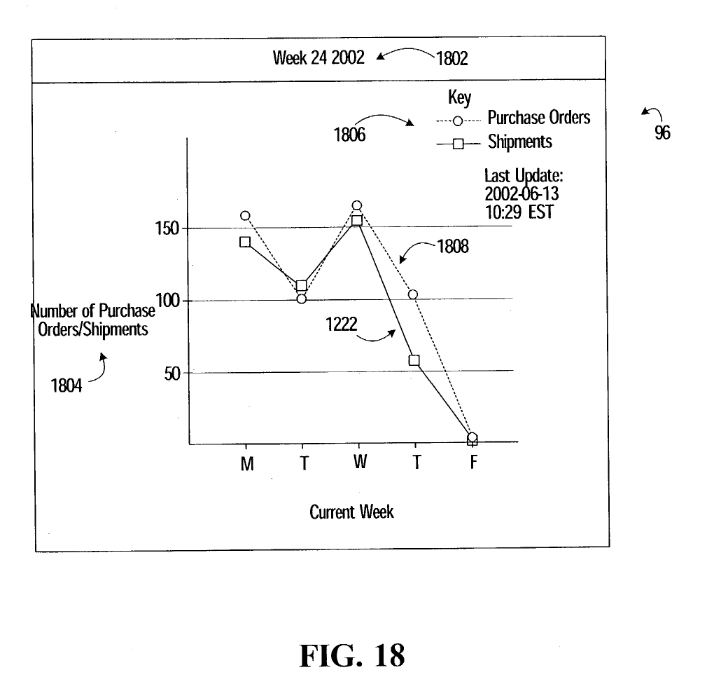

FIGS. 17 and 18 illustrate the capacity of the computing system 10 to be linked to (and to thereby reuse) existing monitoring architecture components (prepared according to the present architecture) from other applications. In particular, an alternative embodiment of the system is illustrated which incorporates purchase order application data from a second legacy application into the package shipment data line graph of FIG. 12.

Referring to FIG. 17, a data flow diagram 1700 illustrates the alternative embodiment of computing system 10 with two added software components: a legacy application 84 and a legacy data collector 86. Application 84 is a legacy software application which tracks purchase orders generated by a business enterprise in response to new orders placed by customers. Data collector 86 is a Java™ object analogous to the data collector 34 which is capable of receiving event notifications 85 representing purchase order generation events from the application 84 and of generating therefrom (on request) a logical, application-data-centric data instance 88 (in the form of a DOM XML document instance) representing a total number of purchase orders generated during each day of the current business week. Both the application 84 and the DC 86 are understood to have been developed by a developer (referred to as the legacy developer) that is distinct from the system architect implementing the computing system 10 described above.

To implement the alternative embodiment, the system architect, desirous of incorporating purchase order information into the line graph 12, determines through appropriate inquiries that application 84 is the appropriate source for the desired purchase order information, and further learns that the data collector 86 has been previously created by the legacy developer for the purposes of another application data monitoring task. The system architect retrieves the legacy application-data-centric schema (not shown) which describes the structure of the logical, application-data-centric data instances generated by the data collector 86.

Using the retrieved schema, as well as the published application-data-centric schema associated with weekly shipments document instance 54, the system architect authors a new transform 44b as a replacement for the transform 44 used in the first-described embodiment. New transform 44b is an XSLT which governs the manner in which the TDP 36 will transform the weekly shipments document instance 54 and the weekly purchase orders document instance 88 into a single line graph document instance 92. This transform 44b is substituted for transform 44 in non-volatile memory 42 (FIG. 2) prior to system operation. Assuming that the transformer object/code generated from the transform 44b is capable of handling more than one DOM document input, the TDP 36 will not require modification because it is already capable of receiving data from multiple data sources specified in the input list parameter to the setDataSource( ) method 67 (FIG. 7); otherwise some hard-coding of the TDP 36 may be necessary to merge the weekly purchase orders document instance 88 and weekly shipments document instance 54.

Operation of the amended version of computing system 10 occurs as shown in FIGS. 14A and 14B, with several exceptions. First, the setDataSource( ) method 67 sets both of DC 34 and DC 86 as data sources for the TDP 36 rather than just for the single DC 34. Second, when the createTransformer( ) method call 1408 (FIG. 14A) is made during system initialization, the business logic that is created is based on transform 44b, rather than transform 44. Third, during system operation, execution of the update( ) method 70 of the TDP 36 at 1452 not only causes the update( ) method 64 (FIG. 4) of the DC 34 to be invoked and the weekly shipments document instance 56 to be retrieved, but it similarly causes an update( ) method of the legacy DC 86 (analogous to the method 64) to be invoked and the weekly purchasing orders document instance 88 to be retrieved. Of course, appropriate updates to the JSP™ 46 are necessary for the first and third enumerated operations, as will be recognized by those skilled in the art. It will be appreciated that the added call to the legacy DC 86 will not entail a source code update if a list and list iteration loop are employed. Fourth, when the transform( ) method call 1458 (FIG. 14B) is made in response to a browser refresh, a line graph document instance 92 is generated which includes line graph information regarding not only package shipments/deliveries but also purchase orders. When this instance 92 is converted to displayable line graph data 94 by the line graph widget 38 and displayed by the browser 16, the result is a line graph 96 as shown in FIG. 18.

As may be seen in FIG. 18, the generated line graph 96 has many of the features of line graph 60 of FIG. 12, including the line 1222 of data points representative of the number of package shipments occurring on each day of the current business week. However, line graph 96 additionally includes a line 1802 of data points representative of the number of purchase orders generated on each day of the current business week. Line graph 96 further has an abbreviated title 1802 “Week 24 2002” and a different Y-axis title 1804 “Number of Purchase Orders/Shipments” to account for the broader set of application data displayed within the line graph. Moreover, a legend 1806 is introduced to assist comprehension of the displayed application data.

Advantageously, the instant dynamic business application data monitoring architecture has facilitated reuse of the legacy data collector 86 as well as the incorporation of application data from a legacy application into the displayed line graph with only the substitution of a transform and an update to the dynamic web page, in at least some cases without any need for software source code updates or a software rebuild. This is especially advantageous in the present case, where the system architect and the legacy developer are not the same person, as the system architect is not required to examine and understand the legacy developer's source code to effect the desired update.

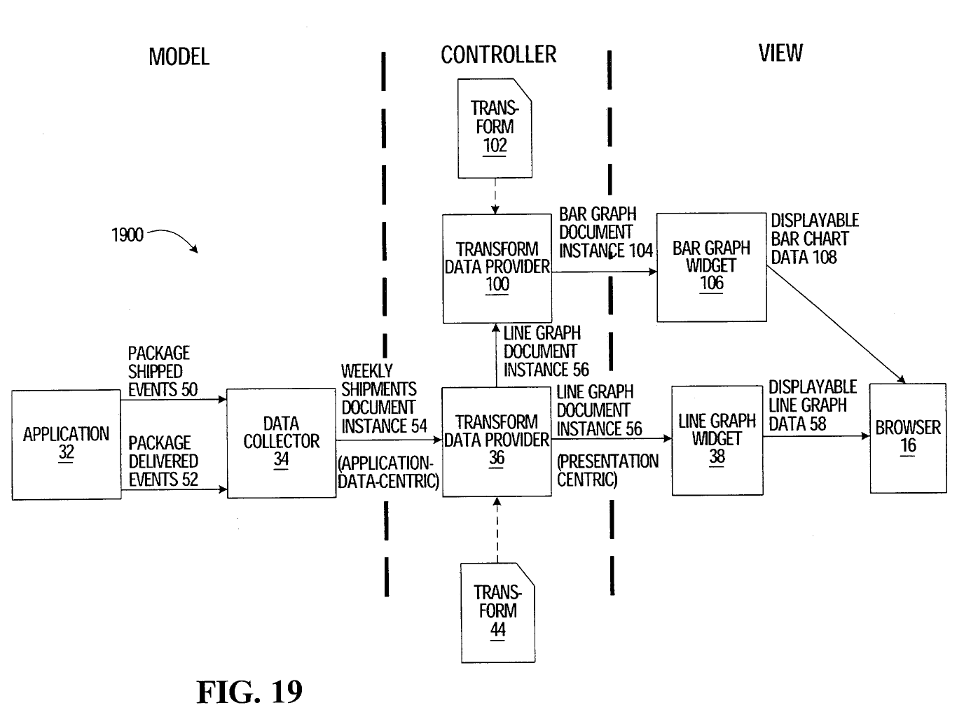

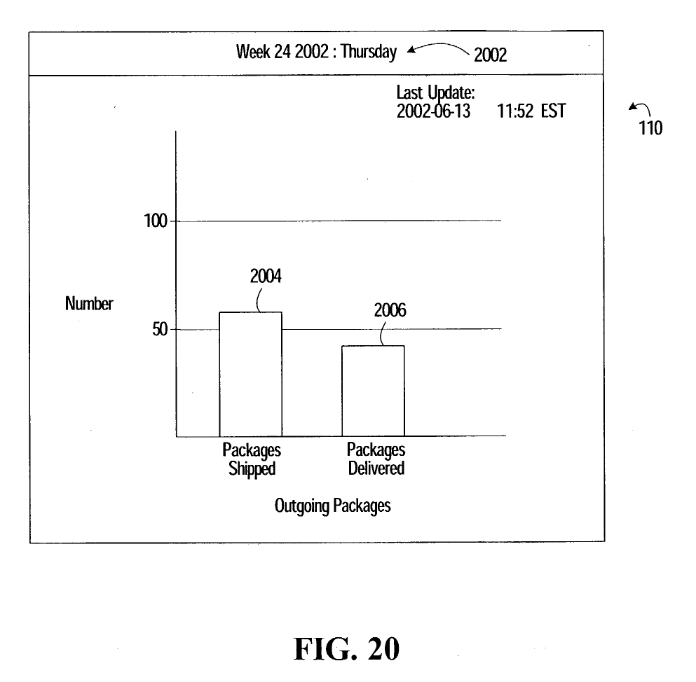

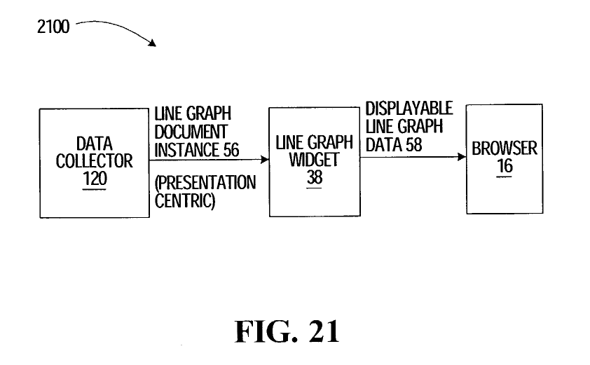

FIGS. 19 and 20 illustrate the capacity of the computing system 10 to be easily modified to display application data by way of multiple display mechanisms. FIGS. 19 and 20 also illustrate the capacity of a data provider to use another data provider as a data source.

Referring to FIG. 19, a data flow diagram 1900 illustrates another alternative embodiment of computing system 10 with two added software components: a second transform data provider 100 and a bar graph widget 106. The purpose of these added components is to support a new bar graph display mechanism which has been added to the JSP™ 46 (in addition to the existing line graph 60) for the purposes of viewing the current day's package shipment and delivery totals in bar graph form. Transform data provider 100 is a Java™ object analogous to the TDP 36 which is capable of receiving a presentation-centric line graph document instance 56 and transforming it into a presentation-centric bar graph document instance 104 which conforms to a third, presentation-centric XML schema that is associated with a bar graph display mechanism (and thus defines elements and attributes that are particular to bar graphs) for displaying a single day's package shipment and delivery totals. It will be appreciated that, unlike the TDP 36, which receives input from its data source in the form of an application-data-centric data instance (instance 54), the TDP 100 receives its input in the form of a presentation-centric data instance (instance 56). This is illustrative of the capacity of transform data providers to receive input data in either of an application-data-centric structure or a presentation-centric structure. TDP 100 is configurable at run time with an external transform 102 which wholly governs the transformation effected by the TDP 100. Both of instances 56 and 104 are DOM XML document instances.

Bar graph widget software object 106 is a Java™ object capable of receiving the presentation-centric data instance 104 comprising bar graph data from transform data provider 100 and generating displayable bar graph data comprising SVG code therefrom. The bar graph widget 106 has a similar structure to line graph widget 38 illustrated in the UML model of FIG. 11.

Operation of this alternative embodiment of computing system 10 occurs as shown in FIGS. 14A and 14B, with several exceptions. During system initialization, method calls analogous to those appearing at lines 13 to 20 of the JSP™ 46 (FIG. 13) are made in order to instantiate the new TDP 100, to set the TDP 36 as its data source, and to create transformer business logic from the transform 102 (the JSP™ 46 of course having been modified to facilitate these calls). Upon a browser refresh, the update( ) method 70 of the TDP 36 is not called as shown at line 38 of the JSP™ 46 (FIG. 13); rather, an analogous call is made to the update( ) method 70 of the TDP 100 in order to ensure that the bar graph data is up-to-date. The latter method in turn invokes the update( ) method 70 and the getDocument( ) method 71 of the TDP 36 for the purpose of retrieving the line graph document instance 56 so that it may be converted to a bar graph document instance 104. When this instance 104 is converted to displayable line graph data 94 by the bar graph widget 106 and displayed by the browser 16, the result is a bar graph 110 as shown in FIG. 20.

As may be seen in FIG. 20, the generated bar graph 110 includes a title 2002 identifying the current day, as well as two bars 2004 and 2006 representing the number of packages shipped and packages delivered, respectively, on that day. Other conventional bar graph features familiar to those skilled in the art also appear in the bar graph 110.

The bar graph 110 may be displayed within the same JSP™ 46 as the line graph 60. Advantageously, the application data shown in the bar graph 110 of FIG. 20 is consistent with the application data appearing within the line graph 60 of FIG. 12 (e.g. the number represented by the bar 2004 and the data point 1218 are the same). This consistency is a beneficial result of a single data source (TDP 36) supplying widgets 106 and 38 with data (either indirectly or directly).

Advantageously, the addition of the bar graph 110 in the manner described above introduces a new application data monitoring mechanism into the computing system 10, with only the provision of a new transform 102, the addition of a TDP 100 (which may be a duplicate of TDP 36), and the addition of a bar graph widget (which may be obtained from a widget library and may thus require no additional coding).

A further alternative embodiment of the computing system is illustrated in FIG. 21. FIG. 21 illustrates a data flow diagram 2100 showing data flow between software components in the alternative embodiment. As may be seen in FIG. 21, in the present alternative embodiment the application 32, data collector 34, transform data provider 36 and transform 44 have been replaced by a single data collector 120. Data collector 120 has a getDocument( ) method, a refresh( ) method, and an update( ) method similar to methods 62, 63 and 64 (respectively) of the DC 34 of FIG. 4. However, data collector 120 differs from the previously described data collector 34 in that it generates line graph document instances 56 directly from internal native format application data. Moreover, like the TDP 36 described above, this DC 120 implements the DOM document interface and thus is itself a DOM document. Further, the DOM document generated by the data collector 120 (i.e. the DC 120) is not application-data-centric, but rather comprises the presentation-centric data instance 56 which conforms to the XML line graph schema 800 (FIGS. 8A & 8B).

Operation of the system illustrated in FIG. 21 is much the same as the operation of the first-described embodiment shown in FIGS. 14A and 14B, albeit simplified. Upon initialization, instantiation of the DC 120 rather than the DC 34 is performed at 1402. Calls 1404, 1406 and 1408 do not occur due to the absence of a transform data provider 36. The call 1420 to the setDataProvider( ) method 78 sets the data collector 120 rather than the transform data provider 36 as the data source for the line graph widget 38. It will be appreciated that this may be facilitated by a design of the setDataProvider( ) method 78 in which the input parameter is a DOM document instance rather than a data provider object, so that the method is not strictly required to receive a data provider object, and can alternatively receive any object that is a DOM document instance, such as DC 120.

Upon the occurrence of a browser refresh, none of calls 1452, 1454, 1456 or 1458 of FIG. 14B occur due to the lack of a TDP 36. Rather, the Java™ Servlet Engine directly calls the update( ) method of the data collector 120. This causes the DC 120 to update itself through internal examination of native format application data and invocation of appropriate DOM API calls to create an updated presentation-centric document instance 56. The remaining steps (starting at 1460) and the display of the resultant line graph are as previously described, with the exception that the getDocument( ) call 1462 is made of the DC 120 rather than of a TDP.

It will be appreciated that the alternative embodiment illustrated in FIG. 21 does not strictly adhere to the MVC paradigm in view of the fact that the Model and Controller components are not separate (both are embodied by the data collector 120). However, the embodiment is nevertheless advantageous in that re-use of the existing widget component 38 for local or remote application data monitoring is facilitated.

As will be appreciated by those skilled in the art, modifications to the above-described embodiment can be made without departing from the essence of the invention. For example, it is not necessary for the application 32 and the HTTP server application 40 to be physically co-located on a single server 26. Rather, the application 32 and HTTP server application 40 may be located on different servers capable of intercommunication. This is also true for the DC 34, TDP 36 and widget 38 (FIG. 3). Further, it is not necessary for any of these components to execute on a web-based server. They could instead be executed on a non web-based based machine, with the generated serialized SVG file being pulled in by a JSP™ or by straight HTML. Alternatively, the browser 16 could be executed on same computing device as the remaining software components (e.g. on server 26), to monitor a local application for example, in which case a data network 24 may be unnecessary.

In another alternative, the distinct presentation-centric schemata to which the presentation-centric data instances 56, 92 and 104 conform may be replaced by a single common schema that is sufficiently flexible to be capable of describing data for different types of graphical display mechanisms, rather than being specific to, e.g., a line graph or a bar graph. The same schema could then be used by all types of widgets. A data provider whose generated data instance conforms to the common schema may then supply that instance to a number of different widgets, regardless of the graphical display mechanism used by the widgets to display the supplied data. This may simplify addition of a new type of widget to an existing system architecture. A common schema could further be amended to exclude widget parameters that are commonly set once and not updated (such widget height or width), which may instead be defined by way of another schema that is instantiated once and referenced by all widgets. The presentation-centric data instances would then be freed of such parameters and would enjoy a reduced scope that includes only more frequently adjusted widget characteristics.

Event notification between the application 32 and the DC 34 is not necessarily implemented using event queues and event notification. Alternative embodiments may employ other event notification techniques, such as other Java™ Message Service (JMS) event publishing implementations or Java™ event listeners for example. In the case where the application 32 is a legacy application, it may be desirable to adopt an event notification mechanism that is more readily retrofitted to the application 40, for the sake of implementation simplicity.

It will also be appreciated that refreshing of a JSP™ is not the only way to trigger data flow between the software components. Event-driven event notification from the DC to the TDP can trigger data flow.

Fundamentally, it is not necessary for native-format application data to be received only from executing applications providing event notifications to data collector software components. Rather, native-format application data may be read directly from application data logs or database files. Indeed, native-format application data may be from virtually any source, provided that that data may be converted to application-data-centric or presentation-centric data instances by a data collector software component. When application data is read from an application data log or database file, amendment and rebuilding of the associated application may advantageously be avoided. If the application logs or database files are static, the application data that is displayed graphically to a user may not change upon a browser refresh.

It will be appreciated that TDP 36 described above is a particular form of data provider which employs an external transform for transforming received data instances into generated data instances. Data providers of alternative embodiments need not utilize transforms to generate data instances.

In alternative widget embodiments, the generateAndSerializeToFile( ) method 81 may be replaced or accompanied by methods which direct SVG code output to a specified string or byte array rather than a file. Moreover, alternative widget embodiments may generate displayable graphics in graphics formats other than SVG, such as WML, HTML, VML, or Macromedia Flash, with JavaScript to support widget interactivity for example. Of course, adoption of an alternative form would necessitate appropriate modifications to the name and logic of the line graph widget's generateAndSerializeToFile( ) method 81. The selected graphics format should preferably be scalable for flexibility of display on various display types and sizes, but this is not a requirement.

It will also be appreciated that the DC 34, TDP 36 and line graph widget 38 are not necessarily object oriented software objects. In alternative embodiments, they may be non-object oriented software entities, provided that they behave in the manner described herein.

Finally, it is not necessarily for the application-data-centric and presentation-centric schemas used in conjunction with the described embodiments to be XML schemas. Other schema types, such as Standard Generalize Markup Language (SGML) Document Type Definitions (DTDs), may be used in alternative embodiments.

Other modifications will be apparent to those skilled in the art and, therefore, the invention is defined in the claims.

What is claimed is:

1. A method of graphically displaying application data for dynamic monitoring comprising:
constructing from native format application data a presentation-centric data instance in which application data is represented as a hierarchy of logical elements representing features of a graphical data display mechanism for displaying said application data, said logical elements being defined in a presentation-centric schema to which said data instance conforms.

2. The method of claim 1 further comprising:
generating from said presentation-centric data instance a displayable representation of said graphical data display mechanism having at least some of said features.

3. The method of claim 2 wherein said constructing comprises:
receiving application data in a native format;
converting said received application data from said native format into another data instance different from said presentation-centric data instance; and
transforming said another data instance into said presentation-centric data instance.

4. The method of claim 3, wherein said receiving and said converting occur in a data collector software component, said transforming occurs in a transform data provider software component, and said generating occurs in a widget software component.

5. The method of claim 3 wherein said another data instance is an application-data-centric data instance in which application data is represented as another hierarchy of other logical elements representative of application data categories unrelated to a graphical data display mechanism for displaying said application data, said other logical elements being defined in an application-data-centric schema to which said another data instance conforms.

6. The method of claim 3 wherein said transforming is governed by a transform that is external to a software component implementing said transforming.

7. The method of claim 6 wherein said transform is an eXtensible Stylesheet Language Transform (XSLT).

8. The method of claim 2 further comprising incorporating said displayable representation of said graphical data display mechanism in a dynamic world wide web page for display at a world wide web browser.

9. The method of claim 8 wherein said constructing and said generating are triggered by a refresh of said world wide web browser.

10. The method of claim 8 wherein said constructing and said generating occur at a server separate from a client computing device executing said world wide web browser.

11. The method of claim 10 wherein said dynamic world wide web page is a Java™ Server Page (JSP™) and wherein said constructing and said generating is performed by at least one object invoked from said JSP™.

12. The method of claim 3 wherein said native format of application data comprises at least one application event notification.

13. The method of claim 3 wherein said native format of application data comprises an application log file.

14. The method of claim 2 wherein said displayable representation is a vector graphics representation.

15. The method of claim 14 wherein said vector graphics representation is in a Scalable Vector Graphics format.

16. The method of claim 1 wherein said presentation-centric schema is an extensible Markup Language (XML) schema.

17. The method of claim 1 wherein said presentation-centric data instance is a Document Object Model (DOM) document instance.

18. The method of claim 17 wherein said DOM document instance is compliant with the DOM Level 2 recommendation.

19. The method of claim 5 wherein said application-data-centric schema is an XML schema.

20. The method of claim 6 wherein said features include aesthetic features of said graphical data display mechanism that are configurable by amending said transform.

21. The method of claim 2, wherein said constructing occurs in a data collector software component and said generating occurs in a widget software component.

22. The method of claim 2 wherein said graphical data display mechanism is selected from the group consisting of a bar graph, a stacked bar graph, a line graph, a pie graph, and a rate indicator.

23. A computer program product having media including computer programmed instructions for directing a computing device to implement the method of any of claims 1 to 22.

24. A presentation-centric schema defining a hierarchy of logical elements representing features of a graphical data display mechanism for displaying application data.

25. A widget software component comprising programmed instructions for directing a computing device to:
receive from an associated data source a presentation-centric data instance in which application data is represented as a hierarchy of logical elements representing features of a graphical data display mechanism for displaying said application data, said logical elements being defined in a presentation-centric schema to which said data instance conforms; and
generate from said presentation-centric data instance a displayable representation of said graphical data display mechanism having at least some of said features.

26. The widget software component of claim 25 further comprising programmed instructions for directing a computing device to:
set said associated data source of said widget software component to a specified data source at run time.

27. A computing device comprising a processor and persistent storage memory in communication with said processor storing processor readable instructions for directing said device to undertake the method of any of claims 1 to 22.
